(19) United States
(12) Patent Application Publication
(10) Pub. No.: US 2004/0260561 A1
(43) Pub. Date: Dec. 23, 2004

(54) Voice-activated programmable remote control

(75) Inventors: Mark Grossmeyer, Cedarburg, WI (US); Myron Hitchcock, Englewood, FL (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Joseph Enterprises, Inc., San Francisco, CA

(21) Appl. No.: 10/753,758

(22) Filed: Jan. 7, 2004

Related U.S. Application Data
(60) Provisional application No. 60/439,265, filed on Jan. 10, 2003.

(51) Int. Cl. G10L 21/00

(52) U.S. Cl. 704/275

(57) ABSTRACT

A voice actuated VCR controller includes increment and decrements buttons, and instruction button. Upon user battery insertion, and audio prompt requesting sequential setting of the day, hour, and minute occurs utilizing the increment and decrements buttons. Presuming the clock is set, and the device turned on, the decision tree protocol is activated. The protocol includes asking sequentially for the day, hour, and minute, AM and/or PM time for both the start and stop of VCR recording. Thereafter, the correct times are verified, the user instructed to turn on his VCR, insert a tape, and place the voice actuated VCR controller addressed to the VCR. In an alternate embodiment, the voice actuated VCR can make a presumption for VCR programming based on information in the controller, announce to the user the presumption and inquiring whether the presumption is correct, receiving an answer to the announced presumption, and in the event that the presumption is incorrect, receiving corrected information.

### CROSS-REFERENCES TO RELATED APPLICATIONS

This Application claims priority from U.S. Provisional Patent Application Ser. No. 60/439,265 filed Jan. 10, 2003 and entitled Voice-Activated Programmable Remote Control.

### STATEMENT AS TO RIGHTS TO INVENTIONS MADE UNDER FEDERALLY SPONSORED RESEARCH OR DEVELOPMENT

NOT APPLICABLE

REFERENCE TO A “SEQUENCE LISTING,” A TABLE, OR A COMPUTER PROGRAM LISTING APPENDIX SUBMITTED ON A COMPACT DISK.

NOT APPLICABLE

This invention relates to the programming of video recording devices (VCR's). More specifically, a video programming device having an oral command capability, has a decision tree protocol interactive with broadcast audio queries, probable command choices, and voice actuated instructions to minimize user confusion.

### BACKGROUND OF THE INVENTION

In Grossmeyer U.S. Pat. No. 5,835,665 entitled Simplified VCR Programmer, I disclose a simplified programmer that provides only the essential input controls required for programming a VCR. This simplified VCR programmer includes directly manipulated input controls for setting the record start time including AM or PM, the record stop time, and the day of the week. All of the manufacturer's record start and record stop codes for most major VCR brands are transmitted sequentially by an IR transmitter to the VCR at the preprogrammed times resulting in the simplified universal programmer being utilized with virtually any VCR.

VCR's are notorious for their difficulty of programming. As a result, any number of so-called “simplified” programming methods has been utilized. For example, in one programming method a sequence of digits is entered into a control device. These digits have no intuitive correlation to the program being recorded, and therefore constitute a mindless “by rote” programming sequence.

I have determined that there is a need for an audio interactive instructing and instructed VCR controller. Simply stated, I combine the capabilities of my Grossmeyer' 665 simplified VCR programmer with a decision tree protocol interactive with broadcast audio queries, selected command choices, voice actuated instructions, and the user toggled increments and decrements to provide a highly intuitive, virtually self instructing VCR controller.

### BRIEF SUMMARY OF THE INVENTION

A voice actuated VCR controller includes increment and decrements buttons, and instruction button. Upon user battery insertion, and audio prompt requesting sequential setting of the day, hour, and minute occurs utilizing the increment and decrements buttons. Presuming the clock is set, and the device turned on, the decision tree protocol is activated. The protocol includes asking sequentially for the day, hour, and minute, AM and/or PM time for both the start and stop of VCR recording. Thereafter, the correct times are verified, the user instructed to turn on his VCR, insert a tape, and place the voice actuated VCR controller addressed to the VCR. In an alternate embodiment, the voice actuated VCR can make a presumption for VCR programming based on information in the controller, announce to the user the presumption and inquiring whether the presumption is correct, receiving an answer to the announced presumption, and in the event that the presumption is incorrect, receiving corrected information.

### BRIEF DESCRIPTION OF THE DRAWINGS

FIG. 1 is a plan view of the controller of this invention illustrating controls for setting the clock, obtaining voice instructions, incrementing and decrementing choices made, and reviewing the set VCR program audibly;

FIG. 2 is a view of the display illustrating the controller clock, the displayed start time, and the displayed stop time; and,

FIG. 3 is a block diagram of the VCR decision tree.

### DETAILED DESCRIPTION OF THE INVENTION

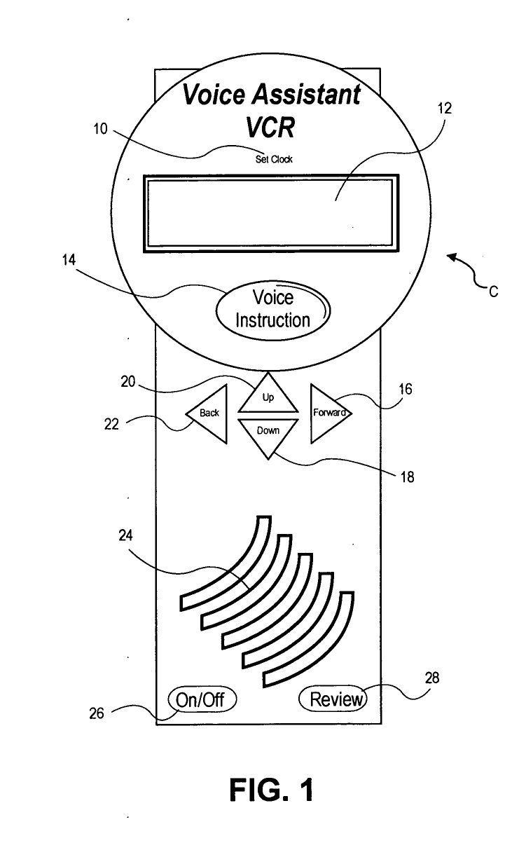

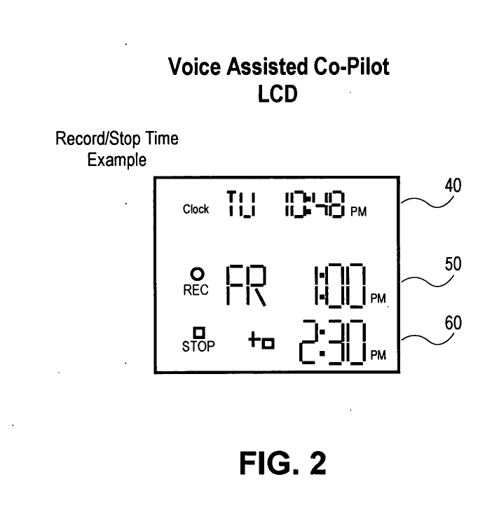

Referring to FIG. 1, an elevation view of the voice assisted VCR controller C of this invention is illustrated. Manual controls on the top face of the voice assisted VCR controller includes clock set 10, display 12 (described in detail in FIG. 2), and voice instruction prompt 14.

Main controls include increment input 20, decrement input 22, field forward 16, and field back 18. As will hereinafter be set forth, field forward and back controls 16, 18 enable movement between the respective query fields. Increment and decrement controls 20, 22 enable stepping the input to the appropriate day, hour, minute, and AM/PM.

Finally in the bottom part of the controller there is provided speaker 24, on off control 26 (a toggle), and review 28. Review 28 functions upon depression to repeat current programming.

Referring to FIG. 2, display 12 and includes clock 40, start time 50, and stop time 60. Each of these respective displays includes day, hour, minute, and AM/PM.

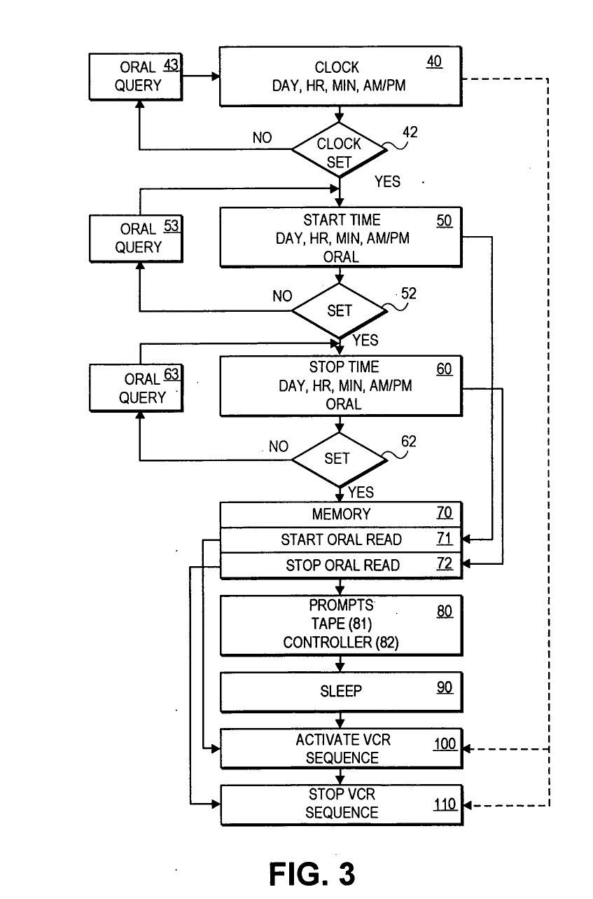

Referring to FIG. 3, the system operates as follows:

The user installs the batteries in the apparatus of FIG. 1. The voice assisted VCR controller C waits 8 seconds for the user to turn the Voice assisted VCR controller over and then says: “Welcome to the Voice Assisted VCR.” The Voice assisted VCR controller continues to say: If you need help at any time, press the Voice Instruction button.

Setting the Clock 40.

Presuming that the clock is not initially set, the Voice assisted VCR controller continues to say: “Before you begin using the voice assisted VCR, you need to set the Voice assisted VCR controller's clock. Set it to the current local time of day. You are ready to set the current time of day. If you need help at any time, press the Voice Instruction button.”

The Voice assisted VCR controller continues to say: “Use the Up and Down buttons to select the current day and then press the enter button.” The user presses the up and down buttons until the correct day is shown on the display. Then the user presses the enter button.

The Voice assisted VCR controller then says: “Set the current hour.” The user presses the up and down buttons until the correct Hour is shown on the display. Then the user presses the enter button. The Voice assisted VCR controller says: “Set the current minute.” The user presses the up and down buttons until the correct minute is shown on the display. Then the user presses the enter button. The Voice assisted VCR controller says: “Set AM or PM.” The user presses the up and down buttons until the correct AM or PM is shown on the display. This completes the cycle illustrated at clock 40, clock set logic 42 and oral query 43.

If the user does not know what to do at any time and does not press any buttons for 10 seconds, the Voice assisted VCR controller says this message every 10 seconds: “If you need help at any time, press the Voice Instruction button.” Then the user presses the Voice Instruction button and is told what to do dependent upon where in the illustrated logic profile of FIG. 3 that the user is located. At the location in the decision tree of FIG. 3, the next in order sequential command will be repeated.

At the conclusion of setting the clock 40, the user presses the enter button. The Voice assisted VCR controller verbally outputs the Day, hour and minutes including AM or PM so the user hears what they set time of day to. (e.g: “The Current time of Day is Friday 3:54 PM”)

The Voice assisted VCR controller then says: “If the time setting is correct press the enter button. To change an entry, press the back button.”

The user presses the enter button. This completes the clock setting process. The clock is now set.

Set the Record Start Time

The setting of the record time is analogous and is illustrated at start time 50, set logic 52, and oral query 53. The clock is now set and the Voice assisted VCR controller will start to tell the users how to set the Record start and stop times. The Voice assisted VCR controller says: “The Voice assisted VCR controller is now on. Step 1, the enter button to set the VCR record time.” The user presses the enter button. The Voice assisted VCR controller says: “Use the Up and Down buttons to select the Record day and then press the enter button.” The user presses the up and down buttons until the correct day is shown on the display. The Voice assisted VCR controller repeats the days as they are displayed. The user then presses the enter button to accept the day selected. The Voice assisted VCR controller says: “Set the hour.” The user presses the up and down buttons until the correct record hour is shown on the display. The Voice assisted VCR controller repeats the hours as they are displayed. When the correct hour appears, the user presses the enter button. The Voice assisted VCR controller says: “Set the Minute.” The user presses the up and down buttons until the correct minute is shown on the display. The Voice assisted VCR controller says the minutes as they are displayed. The user then presses the enter button to accept the minute selected. Finally, the Voice assisted VCR controller says: “Set AM or PM.” The user presses the up and down buttons until the correct AM or PM shown on the display. The Voice assisted VCR controller says the AM/PM as they are displayed. The user then presses the enter button to accept the AM or PM selected.

Set the Record STOP Time

The setting of the stop time is analogous and is illustrated at stop time 60, set logic 62, and oral query 63. The Voice assisted VCR controller says: “Set the STOP hour.” The user presses the up and down buttons until the correct stop hour is shown on the display. The Voice assisted VCR controller repeats the hours as they are displayed. The user presses the enter button. The Voice assisted VCR controller says: “Set the Minute.” The user presses the up and down buttons until the correct minute is shown on the display. The Voice assisted VCR controller repeats the minutes as they are displayed. The user then presses the enter button to accept the minute selected. The Voice assisted VCR controller says: “Set AM or PM.” The user presses the up and down buttons until the correct AM or PM shown on the display. The Voice assisted VCR controller says the AM/PM as they are displayed. The user then presses the enter button to accept the AM or PM selected. At this point, entry is made into memory 70, the start oral read 71, and 72. The Voice assisted VCR controller verbally says the record day, start and stop times (e.g.: “Saturday 8:30 pm to 10:15 PM”) to verify correct programming.

The Voice assisted VCR controller then says: “If the time setting is correct press the enter button. To change an entry, press the back button.” Presuming that the entries are correct, then the user presses the enter button. This places the respective entries in memory 70.

The record time and stop time are now set. The Voice assisted VCR controller now says: to continue press the enter button.

Prompts for Proper VCR Operation.

The Voice assisted VCR controller says: “Turns on your VCR.” at oral prompt 80 at insert tape 81 and turn on VCR 82. The user turns on the VCR and then presses the enter button. The Voice assisted VCR controller says: “Insert a tape.” The user inserts a tape and then presses the enter button. The Voice assisted VCR controller says: “Set the VCR or cable box to the channel you wish to record.” The user set the channel and then presses the enter button. The Voice assisted VCR controller says: “Place the Voice assisted VCR controller pointing at your VCR”

Finally, the Voice assisted VCR controller says: “That's it, you're done! The VCR Voice assisted VCR controller is now ready to record.” At this time the device becomes quiescent. Conventional activation occurs at 100 by the device emitting a series of record signals for all market VCRs. Similarly, conventional stopping occurs at 110 by the device emitting a series of stop signals for all market VCRs.

It is to be understood, that at anytime the user wants Review the Record times they just press the review button and it verbally says the record day, start and stop times. It is to be noted that previously set record and stop times can either be erased upon execution (the preferred, simplified form of this invention) or alternately can serve as presumptions for subsequent record and stop times. In the latter case, the record and stop times will be retained in memory. For example, where a user records the nightly news cast, it will be required that the day (Monday through Sunday) be changed.

If the user wants to turn the Voice assisted VCR controller off they press the ON/Off button. The Voice assisted VCR controller will tell the user that the Voice assisted VCR controller is now respectively on or off.

What is claimed is:

1. A process of operating audio assisted programmable remote control including the steps of:
providing the audio assisted programmable remote control with a clock for receiving and displaying date and time of day;
providing the audio assisted programmable remote control with a memory for retaining settings of the controller including record start times and record stop times;
providing an audio output to the user for announcing queries sequentially by day, hour, minute and AM/PM for start and stop times;
providing an input for receiving answers to the queries;
upon receiving an input answering the queries sufficient for programming including start and stop times, announcing to the user the start and stop times utilizing the audio output to review remote control programming;
queuing the user to activate the VCR for recording; and,
placing the voice activated programmable remote control addressed to the VCR for remote controlling of the VCR.

2. The process of operating audio assisted programmable remote control according to claim 1 including the steps of:
providing an input to actuate a repeat of a query absent an input answering the query.

3. The process of operating audio assisted programmable remote control according to claim 1 wherein step of queuing the user includes:
instructing the user to place recording media in the VCR.

4. A process of operating voice activated programmable remote control including the steps of:
providing a clock for receiving and displaying date and time of day;
providing a memory within the controller for retaining past settings of the controller including record start times and record stop times;
providing an audio output for the user for announcing presumptions;
providing an input for receiving corrections;
making a presumption for VCR programming based on information in the controller;
announcing to the user the presumption utilizing the audio output;
inquiring whether the presumption is correct utilizing the audio output,
receiving an answer to the announced presumption at the input; and,
in the event that the presumption is incorrect, receiving correction to the presumption at the input.

5. The process of operating voice activated programmable remote control of claim 4 including the further step of:
making a presumption for VCR programming start record time utilizing the present date from the clock;
announcing to the user the presumption for the start record time;
inquiring whether are the presumption for this start record time is correct utilizing the audio output;
receiving an answer to the announced presumption of the start record time at the input; and,
in the event that the start record time is incorrect, receiving a corrected start record time at the input.
